(19) United States
(12) Patent Application Publication
(10) Pub. No.: US 2017/0043305 A1
(43) Pub. Date: Feb. 16, 2017

(54) METHOD AND DEVICE FOR PRODUCING HYDROGEN-CONTAINING DRINKING WATER

(71) Applicant: SHEFCO CO., LTD., Tokyo (JP)

(72) Inventor: Junichi IGARASHI, Tochigi (JP)

(21) Appl. No.: 15/307,094

(22) PCT Filed: Apr. 28, 2015
(86) PCT No.: PCT/JP2015/062895

§ 371 Date: Oct. 27, 2016

(30) Foreign Application Priority Data
Apr. 28, 2014 (JP) 2014-092648

(51) Int. Cl. B01F 3/04; C02F 1/68; B01D 19/00; B65B 7/16; A23L 2/54; B01F 3/20; B65B 3/18; C02F 1/20; B01D 63/02

(52) U.S. Cl. CPC B01F 3/04808; C02F 1/20; C02F 1/68; B01D 19/0031; B01D 63/02; A23L 2/54; B01F 3/2021; B65B 3/18; B65B 7/16; C02F 2103/02

(57) ABSTRACT

There are provided a method and apparatus for manufacturing hydrogen-containing drinking water that can fill a packaging container with hydrogen-containing water while suppressing the change of the dissolved hydrogen concentration of the hydrogen-containing water to a low level.

A method of continuously manufacturing hydrogen-containing drinking water includes (A) a deaeration step, (B) a hydrogen dissolving step, (C) a filling step, and (D) a sealing step. Pressure is applied to water flow channels corresponding to hydrogen-containing water, which is to be injected to a packaging container in the filling step, from purified water that is to be supplied to the deaeration step. The filling step includes: a preparation stage of supplying hydrogen-containing water, to which pressure is applied, into a filling device; a deaeration stage of removing gas, which is present in the packaging container, after connecting the packaging container to the filling device; an injection stage of directly injecting the hydrogen-containing water, to which pressure is applied, into the packaging container; and a discharge stage of discharging hydrogen-containing water, which remains in the filling device, into the packaging container by introducing pressurized air into the filling device. The method further includes a step of immediately proceeding to the sealing step (D) when the injection port and the filling port are disconnected from each other.

### TECHNICAL FIELD

The present invention relates to a method and an apparatus for manufacturing hydrogen-containing drinking water.

### BACKGROUND ART

Since hydrogen-containing water (simply referred to as hydrogen water) in which hydrogen gas is dissolved in water has high reducibility, hydrogen-containing water has an effect of suppressing the oxidation of metal and the spoilage of foods, and the improvement of various health disorders can be expected in a case in which hydrogen-containing water is used for food. For this reason, hydrogen-containing water has been in the spotlight in recent years.

For example, as a method of manufacturing hydrogen-containing drinking water, there is a method of dissolving hydrogen gas in raw water, the hydrogen gas being supplied from a gas cylinder, or generated by the electrolysis of water.

However, if hydrogen gas is just supplied into raw water, nitrogen gas, oxygen gas, and the like dissolved in the raw water will interrupt the dissolution of hydrogen gas at room temperature under atmospheric pressure. For this reason, the dissolved hydrogen concentration in the raw water will become substantially lower than saturated hydrogen concentration.

Therefore, there is, for example, proposed a method of efficiently dissolving hydrogen gas by showering raw water into a pressure container for making the raw water to contact hydrogen gas. In the above condition, air has been removed from the pressure container, and the pressure container is then filled with hydrogen gas. Further, the pressure of the hydrogen gas in the pressure container is maintained in the range of 2 to 10 atmospheres (Patent Literature 1).

Moreover, there is proposed a method of efficiently increasing dissolved hydrogen concentration by removing residual gas from water as a raw material and then introducing obtained deaerated water and pressurized hydrogen gas into a gas permeable membrane module so as to dissolve hydrogen gas in the deaerated water (Patent Literature 2). Furthermore, there is proposed a packaging container with a spout that is filled with hydrogen-containing drinking water manufactured by this method. Still further, there is provided a method of sucking the inside of a packaging container with a spout by changing and adjusting a flow channel of a filling nozzle for hydrogen-containing water before the hydrogen-containing water starts to be filled in. Then, the packaging container is filled with hydrogen-containing water, in which hydrogen gas is dissolved, from a hydrogen-containing water tank, which stores the hydrogen-containing water in advance, by changing and adjusting the flow channel of the filling nozzle again (Patent Literature 3).

### CITATION LIST

### Patent Literature

### Patent Literature 1: JP 3606466 B1

### Patent Literature 2: JP 2010-269246 A

### Patent Literature 3: JP 2011-240959 A

### SUMMARY OF INVENTION

### Technical Problem

However, since the manufacturing method disclosed in Patent Literature 1 is a batch type, there are problems in that its productivity is low, and each size of apparatuses manufactured needs to increase in order to mass-produce hydrogen water. Further, there are also problems in that not only hydrogen gas cannot be efficiently dissolved in raw water but also hydrogen concentration is varied in every lot.

Furthermore, in the methods disclosed in Patent Literature 2 and Patent Literature 3, dissolved hydrogen concentration higher than saturated hydrogen concentration can be realized immediately after the manufacture of hydrogen-containing water. However, since hydrogen-containing water is temporarily stored in the hydrogen-containing water tank during the filling thereof and is exposed to the atmospheric pressure, the dissolved hydrogen concentration of hydrogen-containing water is reduced to saturated hydrogen concentration or less.

In a case in which a storage container is filled with hydrogen-containing water at room temperature under atmospheric pressure and is sealed up as described above, dissolved hydrogen is evaporated and discharged to the outside air until the storage container is sealed up. For this reason, the dissolved hydrogen concentration of the hydrogen-containing water filled in the storage container becomes much lower than the dissolved hydrogen concentration of hydrogen-containing water immediately after the manufacture of the hydrogen-containing water. As a result, there is also a problem in that the quality of the hydrogen-containing water deteriorates.

### Solution to Problem

As a result of earnest investigation to solve the above-mentioned problems, the inventor found out the followings. That is, it becomes possible to significantly increase dissolved hydrogen concentration in hydrogen-containing water while reducing dissolved oxygen concentration even immediately after the hydrogen-containing water is filled into the packaging container. Further, particularly, it becomes possible to fill the packaging container with the hydrogen-containing water while preventing the dissolved hydrogen concentration in the hydrogen-containing water from being reduced to a low level in filling. This becomes achievable by applying pressure, significantly higher than pressure in the related art, to water flow, that is, between purified water supplied to a deaeration device and hydrogen-containing water injected to a packaging container. Still further, in the present invention, the pressurized hydrogen-containing water becomes directly injectable into the packaging container without being stored in a tank, etc.

That is, the present invention relates to an apparatus for continuously manufacturing hydrogen-containing drinking water, the apparatus including:

(a) a deaeration device that deaerates purified water of a supplied raw material through a hollow fiber membrane;

(b) a hydrogen dissolution device that dissolves pressurized hydrogen gas in deaerated water, which is supplied from the deaeration device, through the hollow fiber membrane;

(c) a filling device that fills a packaging container with a spout from an injection port of the packaging container with hydrogen-containing water supplied from the hydrogen dissolution device;

(d) a sealing device that seals the injection port of the packaging container with a spout completely filled with the hydrogen-containing water;

a pressure pump that is capable of applying pressure to water flow channels corresponding to the hydrogen-containing water, which is to be injected to the packaging container by the filling device (c), from the purified water that is to be supplied to the deaeration device (a);

a relief valve that is connected to a loop flow channel allowing the water flow channel, to which pressure has been applied by the pressure pump, to communicate with the water flow channel to which pressure is not yet applied, closes the loop flow channel when water pressure of the water flow channel to which pressure has been applied is lower than a certain reference pressure, and opens the loop flow channel when the water pressure exceeds the certain reference pressure; and

an orifice that is connected to the water flow channel provided ahead of the filling device (c) and limits the flow rate of hydrogen-containing water, to which the reference pressure is applied and which is to be supplied to the filling device (c), to a certain reference flow rate or less,

wherein the filling device (c) includes a cavity that is formed in a device body and is connected to a filling port, and includes a stem valve that is capable of reciprocating so that a tip portion of the stem valve faces the filling port,

the cavity communicates with the water flow channel extending from the hydrogen dissolution device (b),

the stem valve is a valve mechanism that allows the injection port of the packaging container, which is connected to the filling port, to communicate with the water flow channel extending from the hydrogen dissolution device (b) and blocks the communication of the injection port by the reciprocation thereof,

the cavity is connected to gas decompression means and gas pressurization means through a gas channel that is formed in the stem valve or formed along an outer surface of the stem valve, and

the gas channel is adapted to be opened and closed by the reciprocation of the stem valve.

In the manufacturing apparatus, it is preferable that the reference pressure applied by the pressure pump is in the range of 0.1 MPa to 0.5 MPa.

In addition, the present invention relates to a method of continuously manufacturing hydrogen-containing drinking water, the method including:

(A) a deaeration step of deaerating purified water of a supplied raw material through a hollow fiber membrane in a deaeration device and sending obtained deaerated water to a hydrogen dissolution device;

(B) a hydrogen dissolving step of dissolving pressurized hydrogen gas in the supplied deaerated water through a hollow fiber membrane in the hydrogen dissolution device and sending obtained hydrogen-containing water to a filling device;

(C) a filling step of filling a packaging container with a spout from an injection port of the packaging container with the supplied hydrogen-containing water in the filling device; and

(D) a sealing step of sealing the injection port of the packaging container with a spout filled with the hydrogen-containing water,

the hydrogen-containing water to which pressure is applied being supplied to the filling device, by applying pressure to water flow channels corresponding to the hydrogen-containing water, which is to be injected to the packaging container in the filling step (C), from the purified water, which is to be supplied to the deaeration device in the deaeration step (A), by the operation of a pressure pump,

wherein the filling step (C) includes
a preparation stage of making a state in which a stem valve closes a filling port of the filling device and the hydrogen-containing water to which pressure applied from the hydrogen dissolving step (B) is applied is supplied into a cavity connected to the filling port,
a deaeration stage of connecting the injection port of the packaging container to the filling port and subsequently removing gas, which is present in the packaging container, through a gas channel of the stem valve by gas decompression means,
an injection stage of closing the gas channel, allowing the stem valve to open the filling port, and directly injecting the hydrogen-containing water, to which pressure is applied, into the packaging container, and
a discharge stage of discharging hydrogen-containing water, which remains in the filling device, into the packaging container by opening the gas channel and introducing pressurized air into the cavity through the gas channel by gas pressurization means after the stem valve closes the filling port, and

the method includes:

a step of immediately proceeding to the sealing step (D) when the injection port and the filling port are disconnected from each other.

In the method of manufacturing hydrogen-containing drinking water according to the present invention, it is preferable that when water pressure of the water flow channel to which pressure has been applied by the pressure pump exceeds a certain reference pressure, a relief valve connected to a loop flow channel extending to the water flow channel, to which pressure is not yet applied, from the water flow channel to which pressure has been applied is opened so that hydrogen-containing water, to which the reference pressure is applied, is capable of being stably supplied to the filling device.

In addition, it is preferable that an operation of the stem valve for opening and closing the filling port is periodically repeated in the filling step (C), and the flow rate of the hydrogen-containing water, which is supplied to the filling device from the hydrogen dissolving step (B) and to which the reference pressure is applied, is limited to a certain reference flow rate or less by an orifice.

Meanwhile, it is preferable that the method of manufacturing hydrogen-containing drinking water of the invention is performed using the above-mentioned manufacturing apparatus.

Further, in the manufacturing method, it is preferable that the reference pressure applied by the operation of the pressure pump is in the range of 0.1 MPa to 0.5 MPa, that is, pressure to be added to atmospheric pressure is in the range of 0.1 MPa to 0.5 MPa.

### Advantageous Effects of Invention

The manufacturing apparatus of the present invention is allowed to fill a packaging container with hydrogen-containing water with no significant reduction in the dissolved hydrogen concentration of the hydrogen-containing water obtained immediately after hydrogen gas has been dissolved. That is, the present invention can maintain the dissolved hydrogen concentration value in the hydrogen-containing water filled into the packaging container at a rate much higher than that of the manufacturing method in the related art. Further, the present invention can maintain the high dissolved hydrogen concentration regardless of whether a long period (days) has passed after the hydrogen-containing water had been manufactured. Accordingly, since the manufacturing apparatus of the invention is very suitable for the highly efficient use of the manufacturing method of the invention, the effect of the manufacturing method of the invention to be described below can be sufficiently obtained.

Further, according to the manufacturing method of the invention, it is possible to increase the dissolved hydrogen concentration of hydrogen-containing water to be obtained, to reduce dissolved oxygen concentration, and particularly, to fill the packaging container with the hydrogen-containing water while maintaining high dissolved hydrogen concentration of hydrogen-containing water that is obtained immediately after the dissolution of hydrogen gas. That is, it is possible to manufacture hydrogen-containing water in which the dissolved hydrogen concentration of the hydrogen-containing water filled into the packaging container is maintained at a level substantially equal to the dissolved hydrogen concentration of the hydrogen-containing water, which is obtained immediately after the dissolution of hydrogen gas, and to maintain the high dissolved hydrogen concentration of a hydrogen-containing water product even though a long period (days) has passed after the manufacture of the hydrogen-containing water.

### BRIEF DESCRIPTION OF DRAWINGS

FIG. 1 is a diagram illustrating an aspect of an apparatus for manufacturing hydrogen-containing drinking water that can be used in a method of manufacturing hydrogen-containing drinking water of the invention.

FIG. 2 is a diagram illustrating an aspect of a hollow fiber membrane module that is used in a deaeration tower of FIG. 1.

FIG. 3 is a diagram illustrating an aspect of a hollow fiber membrane module that is used in a hydrogen dissolution tower of FIG. 1.

FIGS. 4(a) and 4(b) are diagrams illustrating a step of filling a packaging container with a spout with hydrogen-containing water in a manufacturing method in the related art.

FIG. 5 is a diagram illustrating a preparation stage of the step of filling the packaging container with a spout with hydrogen-containing water in the apparatus for manufacturing hydrogen-containing drinking water that can be used in the manufacturing method of the invention.

FIG. 6 is a diagram illustrating a deaeration stage of the step of filling the packaging container with a spout with hydrogen-containing water in the apparatus for manufacturing hydrogen-containing drinking water that can be used in the manufacturing method of the invention.

FIG. 7 is a diagram illustrating an injection stage of the step of filling the packaging container with a spout with hydrogen-containing water in the apparatus for manufacturing hydrogen-containing drinking water that can be used in the manufacturing method of the invention.

FIG. 8 is a diagram illustrating the injection stage of the step of filling the packaging container with a spout with hydrogen-containing water in the apparatus for manufacturing hydrogen-containing drinking water that can be used in the manufacturing method of the invention.

FIG. 9 is a diagram illustrating a discharge stage of the step of filling the packaging container with a spout with hydrogen-containing water in the apparatus for manufacturing hydrogen-containing drinking water that can be used in the manufacturing method of the invention.

FIG. 10 is a flow diagram of the step of filling the packaging container with a spout with hydrogen-containing water in the apparatus for manufacturing hydrogen-containing drinking water that can be used in the manufacturing method of the invention.

### DESCRIPTION OF EMBODIMENTS

As described above, a method of temporarily storing hydrogen-containing water, in which hydrogen gas is dissolved, in a hydrogen-containing water tank and filling a packaging container with a spout with the hydrogen-containing water has been employed in the manufacturing method in the related art.

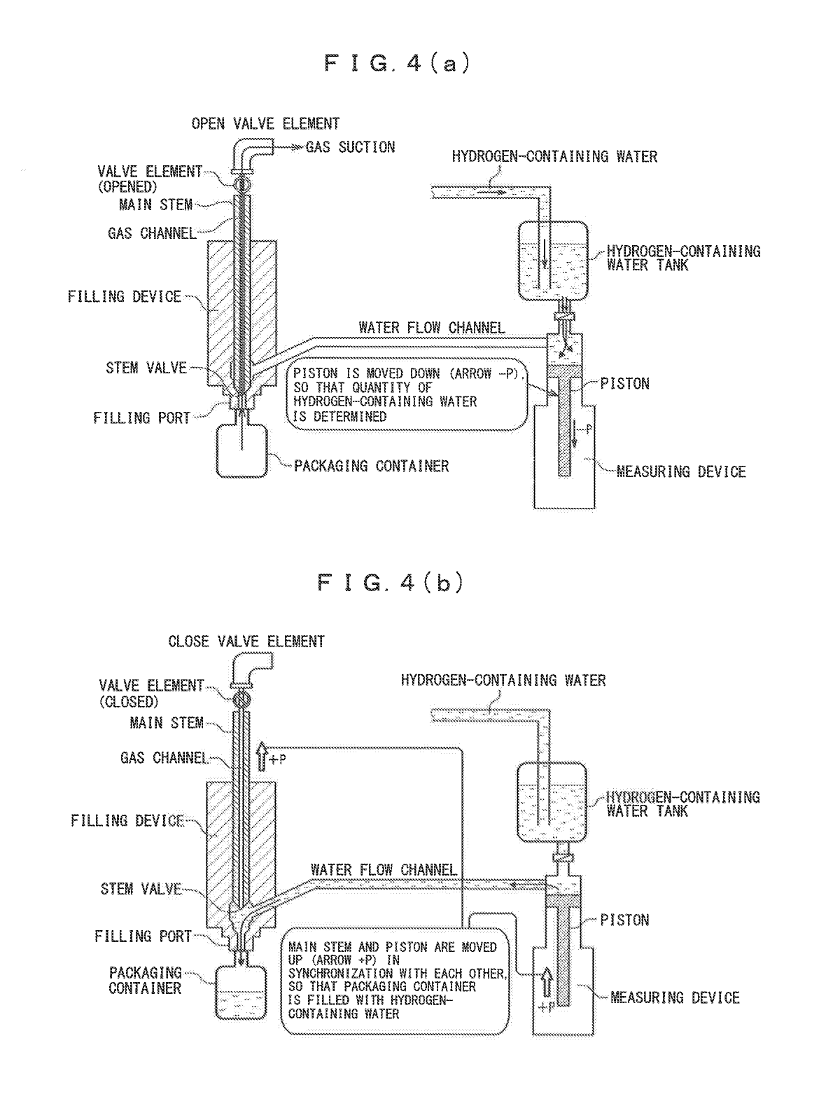

FIGS. 4 (a) and 4 (b) illustrate an example of a filling device in the manufacture of hydrogen-containing water in the related art and an example of a filling method using the filling device.

As illustrated in FIGS. 4 (a) and 4 (b), a measuring device, which includes a hydrogen-containing water tank and a piston used to eject a predetermined amount of hydrogen-containing water from the hydrogen-containing water tank, and a filling device, which is connected to the measuring device through a water flow channel, are used in a filling method for hydrogen-containing water in the related art. The filling device includes a filling port through which the packaging container is filled with hydrogen-containing water, and a stem valve that can open and close the filling port. The stem valve reciprocates while being interlinked with the piston. That is, when the piston is moved up (+P) as illustrated in FIG. 4 (b), the stem valve is moved up (+P). Accordingly, the filling port and the water flow channel, which extends from the measuring device, communicate with each other. Further, when the piston is moved down (−P) as illustrated in FIG. 4(a), the stem valve is moved down. Accordingly, the communication between the filling port and the water flow channel, which extends from the measuring device, is blocked. Further, a gas channel in which gas can flow is formed in an upper portion of the stem valve, and a valve element, which allows the gas channel and a decompression device (not illustrated) to communicate with each other or blocks the communication between the gas channel and the decompression device, is provided at the upper portion of the stem valve. Hydrogen-containing water can be measured and filled into the packaging container with a spout through the filling port by this mechanism.

A specific filling step is as follows.

First, manufactured hydrogen-containing water is temporarily stored in the hydrogen-containing water tank as illustrated in FIG. 4(a). Then, when the piston connected to the hydrogen-containing water tank is moved down, a predetermined amount of hydrogen-containing water is measured. At this time, the stem valve of the filling device blocks the communication between the water flow channel, which extends from the measuring device, and the filling port. In this state, that is, before the packaging container with a spout starts to be filled with hydrogen-containing water, gas remaining in the packaging container is removed by suction through the gas channel formed in the stem valve.

After gas is completely removed from the packaging container with a spout by suction, the stem valve of the filling device and the piston of the measuring device are moved up in synchronization with each other. Accordingly, hydrogen-containing water is sent to the filling device from the measuring device through the water flow channel, and the packaging container with a spout is filled with hydrogen-containing water from the filling port of the filling device.

As described above, in the related art, the use of the measuring device using the piston and the use of the hydrogen-containing water tank required for the use of the measuring device have been essential to measure a predetermined amount of hydrogen-containing water that fills the packaging container with a spout. Further, hydrogen-containing water has been stored in the hydrogen-containing water tank and has been exposed to the atmospheric pressure, that is, hydrogen-containing water has been temporarily stored under ambient pressure environment. For this reason, even though high dissolved hydrogen concentration can be realized immediately after the manufacture of hydrogen-containing water, hydrogen dissolved in hydrogen-containing water is liberated (evaporated) as hydrogen gas when the hydrogen-containing water is stored under ambient pressure environment. As a result, dissolved hydrogen concentration has been reduced.

The inventor investigated not only a method of increasing the dissolved hydrogen concentration of hydrogen-containing water but also a method of filling a packaging container with hydrogen-containing water while maintaining high dissolved hydrogen concentration of hydrogen-containing water.

Then, the inventor removes the measuring device and the hydrogen-containing water tank, which have been used to fill a packaging container with hydrogen-containing water until now, and has made a method and apparatus for increasing the dissolved hydrogen concentration of hydrogen-containing water, which are also made in consideration of safety, in addition to a method and apparatus for directly sending hydrogen-containing water, which is manufactured in a hydrogen dissolving step, to a filling device (without storing the hydrogen-containing water).

The invention will be described in detail below.

<Method of Manufacturing Hydrogen-Containing Drinking Water>

A method of continuously manufacturing hydrogen-containing drinking water of the invention includes at least (A) a deaeration step, (B) a hydrogen dissolving step, (C) a filling step, and (D) a sealing step.

Pressure, which is much higher than pressure in the related art, can be applied to water flow channels corresponding to hydrogen-containing water, which is to be injected to a packaging container in the filling step (C), from purified water, which is to be supplied to the deaeration device in the deaeration step (A), by the operation of a pressure pump, so that the hydrogen-containing water to which pressure is applied is supplied to a filling device. For example, since reference pressure in the range of 0.1 MPa to 0.5 MPa to be described below is applied, hydrogen-containing water to which the reference pressure is applied is supplied to the filling device.

Further, the filling step (C) includes a plurality of successive stages to be described below.

That is, the filling step (C) includes a preparation stage of making a state in which a stem valve closes a filling port of the filling device and hydrogen-containing water to which pressure (reference pressure) applied from the hydrogen dissolving step (B) is applied is supplied into a cavity connected to the filling port,

a deaeration stage of connecting an injection port of the packaging container to the filling port and subsequently removing gas, which is present in the packaging container, through a gas channel of the stem valve by gas decompression means,

an injection stage of closing the gas channel, allowing the stem valve to open the filling port, and directly injecting the hydrogen-containing water, to which pressure (reference pressure) is applied, into the packaging container, and

a discharge stage of discharging hydrogen-containing water, which remains in the filling device, into the packaging container by opening the gas channel and introducing pressurized air into the cavity through the gas channel by gas pressurization means after the stem valve closes the filling port.

The method includes a step of immediately proceeding to the sealing step (D) when the injection port and the filling port are disconnected from each other.

When water pressure of the water flow channel to which pressure has been applied by the pressure pump exceeds a certain reference pressure (for example, 0.1 MPa to 0.5 MPa), a relief valve connected to a loop flow channel extending to the water flow channel, to which pressure is not yet applied, from the water flow channel to which pressure has been applied is opened. Accordingly, hydrogen-containing water to which the reference pressure is applied can be stably supplied to the filling device.

Further, an operation of the stem valve for opening and closing the filling port is periodically repeated in the filling step (C), and the flow rate of the hydrogen-containing water, which is supplied to the filling device from the hydrogen dissolving step (B) and to which the reference pressure is applied, is limited to a certain reference flow rate or less by an orifice. Accordingly, it is possible to set the amount of hydrogen-containing water that is to be filled into the packaging container by the filling device.

Further, it is possible to maintain the amount of hydrogen-containing water that is to be filled into the packaging container, at a set certain amount of hydrogen-containing water by lastly discharging hydrogen-containing water, which remains in the filling device, into the packaging container in the filling step (C).

The manufacturing method of the invention can be suitably performed using, for example, an apparatus for manufacturing hydrogen-containing drinking water of the invention to be described below.

<Apparatus for Manufacturing Hydrogen-Containing Drinking Water>

An apparatus for continuously manufacturing hydrogen-containing drinking water of the invention includes at least (a) a deaeration device, (b) a hydrogen dissolution device, (c) a filling device, and (d) a sealing device.

Each device will be described in detail below.

(a) Deaeration Device

This device is a device that deaerates purified water of a supplied raw material through a hollow fiber membrane.

As long as the deaeration device (a) can remove dissolved gas, such as oxygen gas, nitrogen gas, or carbon dioxide, the deaeration device (a) is not particularly limited. For example, a vacuum deaeration device or a deaeration device including a hollow fiber membrane module can be used, but it is preferable that the deaeration device including the hollow fiber membrane module is used to efficiently remove a very small amount of dissolved gas.

The hollow fiber membrane module includes a plurality of hollow fiber membranes that are generally disposed in the form of a bundle with an appropriate space interposed therebetween; is partitioned into water chambers and a gas chamber by the hollow fiber membranes; and deaerates dissolved gas, which flows in the water chambers, by allowing the purified water to permeate the water chambers to decompress the gas chamber.

Further, two or more hollow fiber membrane modules may be used in parallel, and it is possible to more efficiently remove a very small amount of dissolved gas by particularly using two or more hollow fiber membrane modules in series.

Furthermore, since pressure is applied to the water flow channel through which purified water is supplied to the deaeration device in the invention, the hollow fiber membrane used in this device requires high pressure resistance. However, as long as the hollow fiber membrane has such pressure resistance, the type of the hollow fiber membrane is not particularly limited. For example, polymer membranes, such as polypropylene, polydimethylsiloxane, a polycarbonate-polydimethylsiloxane block copolymer, a polyvinyl phenol-polydimethylsiloxane-polysulfone block copolymer, poly (4-methyl pentene-1), poly (2, 6-dimethyl phenylene oxide), and polytetrafluoroethylene, can be used as the hollow fiber membrane.

Meanwhile, since high pressure is applied to the water flow channel through which purified water is supplied to the deaeration device in the invention, there is a concern that the hollow fiber membrane used in this device may be more quickly consumed than in the related art in which low pressure is applied to a water flow channel. Accordingly, it is preferable that a hollow fiber membrane having more excellent pressure resistance is employed.

Meanwhile, the deaeration of purified water may be performed under a heating condition in order to increase the efficiency of deaeration. In this case, the purified water needs to be cooled to a lower temperature, that is, at least room temperature (about 25° C.) in order to increase the efficiency of the dissolution of hydrogen later.

Meanwhile, purified water used in the deaeration device (a) can be obtained through the filtration of water serving as a raw material in, for example, a purification device.

As long as water serving as a raw material is water supplied from a drinkable water source, the water serving as a raw material is not particularly limited and tap water (water supplied from a water supply provided for a water supply business, a water supply for exclusive use, or a temporary water supply for exclusive use), underground water, or the like can be used.

The purification device generally includes an activated-carbon-filtration unit and a membrane-filtration unit.

The removal of the musty odor of water serving as a raw material and trihalomethane, dechlorination, and the like are performed by the activated-carbon-filtration unit. Further, floating matters (including activated carbon and the like), bacteria, such as coli bacilli, protozoan pathogen, such as cryptosporidium, and the like can also be removed by the safety filter-filtration unit.

Examples of a membrane, which can be used in the membrane-filtration unit, includes a microfiltration membrane (MF film), an ultrafiltration membrane (UF membrane), a nano-filter membrane (NF membrane), and a reverse osmosis membrane (RO membrane). However, considering operability or the residual property of a mineral component that is means for determining a taste in the case of drinking, it is most preferable that the MF film is used. When the NF membrane or the PO membrane is used, mineral components dissolved in raw water, such as sodium ions or potassium ions, are easily removed. Accordingly, in order to make drinkable water, the residual ratios of these mineral components need to be adjusted or materials need to be newly added to the raw water in post-steps. Moreover, since operation becomes complicated in this case, it is not preferable that the NF membrane or the RO membrane is used.

(b) Hydrogen Dissolution Device

This device is a device that dissolves pressurized hydrogen gas in the deaerated water, which is supplied from the deaeration device (a), through the hollow fiber membranes.

Since the amount of hydrogen gas to be dissolved per unit time and unit space is large and the dissolution efficiency of hydrogen gas is easily improved in the case of a hydrogen dissolution device including a hollow fiber membrane module, the hydrogen dissolution device including the hollow fiber membrane module is used as the hydrogen dissolution device (b).

The hollow fiber membrane module includes a plurality of hollow fiber membranes that are generally disposed in the form of a bundle with an appropriate space interposed therebetween; is partitioned into water chambers and a gas chamber by the hollow fiber membranes; and dissolves hydrogen gas in the deaerated water, which flows in the water chambers, by allowing the deaerated water to permeate the water chambers to supply hydrogen gas to the gas chamber.

Further, two or more hollow fiber membrane modules may be used in parallel, and it is possible to further improve the dissolution efficiency of hydrogen gas by particularly using two or more hollow fiber membrane modules in series.

Furthermore, since pressure is applied to the water flow channel through which deaerated water is supplied to the hydrogen dissolution device in the invention, the hollow fiber membrane used in this device requires high pressure resistance. However, as long as the hollow fiber membrane has such pressure resistance, the type of the hollow fiber membrane is not particularly limited. The polymer membranes, which are used as the above-mentioned hollow fiber membrane, can be used as the hollow fiber membrane used in this device.

A method of supply hydrogen gas is not particularly limited. For example, pressure is applied to a commercially available highly pure-hydrogen gas cylinder or hydrogen gas, which is obtained from the electrolysis of water or the like, so that hydrogen gas is supplied to the gas chamber of the hollow fiber membrane module. Here, the pressure to be applied to hydrogen gas is in the range of, for example, 0.1 MPa to 0.5 MPa, that is, pressure to be further added to atmospheric pressure (about 0.1 MPa) is in the range of 0.1 MPa to 0.5 MPa. It is possible to further increase dissolved hydrogen concentration by applying pressure to hydrogen gas.

Meanwhile, in the invention, as described below, high pressure is applied to a water flow channel through which deaerated water is supplied to the hydrogen dissolution device (b). For this reason, since there is a concern that the hollow fiber membrane used in this device may be more quickly consumed than in the related art in which low pressure is applied to a water flow channel, it is preferable that a hollow fiber membrane having more excellent pressure resistance is employed as the hollow fiber membrane.

The manufacturing apparatus of the invention includes a pressure pump that is capable of applying pressure to water flow channels corresponding to the hydrogen-containing water, which is to be injected to the packaging container by a filling device (c) to be described below, from the purified water that is to be supplied to the deaeration device (a). Accordingly, hydrogen-containing water, to which pressure much higher than pressure in the related art is applied and of which dissolved hydrogen concentration is high, can be transported to the filling device through the water flow channel.

As long as the pressure pump can apply pressure to the water flow channel (pipe), the pressure pump is not particularly limited and a well-known pressure pump can be used.

Further, the manufacturing apparatus of the invention is provided with a loop flow channel allowing the water flow channel (that is, the water flow channel extending toward the deaeration device (a)), to which pressure has been applied by the pressure pump, to communicate with the water flow channel to which pressure is not yet applied by the pressure pump.

A relief valve is connected to the loop flow channel. When the water pressure of the water flow channel to which pressure has been applied by the pressure pump exceeds a certain reference pressure, the relief valve functions to open the loop flow channel. While the water pressure is lower than a certain reference, the relief valve functions to close the loop flow channel. That is, since water circulation between the pressure pump and the loop flow channel is frequently performed by the opening and closing of the relief valve, the relief valve has a role to maintain the water pressure at the reference pressure or less.

In terms of the consumption of the hollow fiber membrane, the pressure resistance of each device, and the like, a pressure in the range of, for example, 0.1 MPa to 0.5 MPa is applied as the reference pressure, and the pressure is preferably in the range of, for example, 0.1 MPa to 0.4 MPa and in the range of, for example, 0.1 MPa to 0.3 MPa. That is, a pressure in the range of 0.1 MPa to 0.5 MPa is applied to the water flow channel as pressure to be further added to atmospheric pressure (about 0.1 MPa).

The manufacturing apparatus of the invention includes an orifice that is provided on the water flow channel provided ahead of the filling device (c) to be described below, for example, on the water flow channel between, for example, the hydrogen dissolution device (b) and the filling device (c). The orifice has a role to limit the flow rate of hydrogen-containing water, to which the reference pressure is applied by the pressure pump and which is to be supplied to the filling device (c), to a certain reference flow rate or less. The water pressure of the water flow channel is reduced with the start of the injection of hydrogen-containing water into the packaging container. However, when the orifice is provided, it is possible to suppress reduction in pressure in comparison with a case in which the orifice is not provided. Accordingly, hydrogen-containing water is stably supplied to the filling device. The orifice also has a role to smoothly and safely fill the packaging container with hydrogen-containing water as described above.

(c) Filling Device

This device is a device that fills the packaging container with a spout from an injection port of the packaging container with hydrogen-containing water supplied from the hydrogen dissolution device (b).

Since a bursiform container with a spout, which is made of an aluminum laminate film, particularly has excellent airtightness and can prevent the leakage of hydrogen, it is preferable that the bursiform container with a spout, which is made of an aluminum laminate film, is used as the packaging container with a spout.

The filling device (c) includes a cavity that is formed in a device body and is connected to the filling port, and includes a stem valve that is capable of reciprocating so that a tip portion of the stem valve faces the filling port. Further, the cavity communicates with the water flow channel extending from the hydrogen dissolution device (b), and the stem valve is a valve mechanism that allows the injection port of the packaging container, which is connected to the filling port, to communicate with the water flow channel extending from the hydrogen dissolution device (b) and can block the communication of the injection port by the reciprocation thereof.

Furthermore, the cavity, which is provided in the device body, is connected to gas decompression means and gas pressurization means through a gas channel that is formed in the stem valve or formed along an outer surface of the stem valve. The gas channel is adapted to be opened and closed by the reciprocation of the stem valve, that is, the gas channel and the cavity are allowed to communicate with each other and the communication between the gas channel and the cavity is blocked by the reciprocation of the stem valve.

The stem valve is set so as to periodically reciprocate. Accordingly, the filling port is periodically opened and closed. Meanwhile, the gas channel is also periodically opened and closed while being interlinked with the periodic reciprocation of the stem valve.

Then, while the filling port is opened, hydrogen-containing water is injected into the packaging container. The amount of hydrogen-containing water to be filled by the filling device can be set by the period of the reciprocation of the stem valve (the opening and closing of the filling port) and the setting of a reference flow rate adjusted by the orifice (the diameter of the orifice).

(d) Sealing Device

This device is a device that seals the injection port of the packaging container with a spout completely filled with hydrogen-containing water.

As long as this device can immediately seal the injection port of the packaging container with a spout sent from the filling device, this device is not particularly limited and a well-known sealing device can be used.

Then, after the sealing step ends, the packaging container with a spout is sent to an appropriate heat sterilizer and is completed as a final product by being subjected to heat sterilization.

For example, a heating steam sterilizer can be used as the heat sterilizer, and it would be preferable that heating temperature and heating time during the sterilization are appropriately determined in consideration of an F value (heating period (min.) required to kill a predetermined number of specific bacterial spores or bacteria at a predetermined temperature) or the quality of a product. For example, heating temperature is in the range of 85° C. to 90° C., heating time is in the range of 20 minutes to 1 hour. For example, a heating time of 30 minutes and a heating temperature of 85° C. are employed.

### Example

A preferred embodiment of the invention will be described in detail with reference to the drawings, but the invention is not limited by the embodiment.

[Example Method of Manufacturing Hydrogen-Containing Drinking Water of Invention]

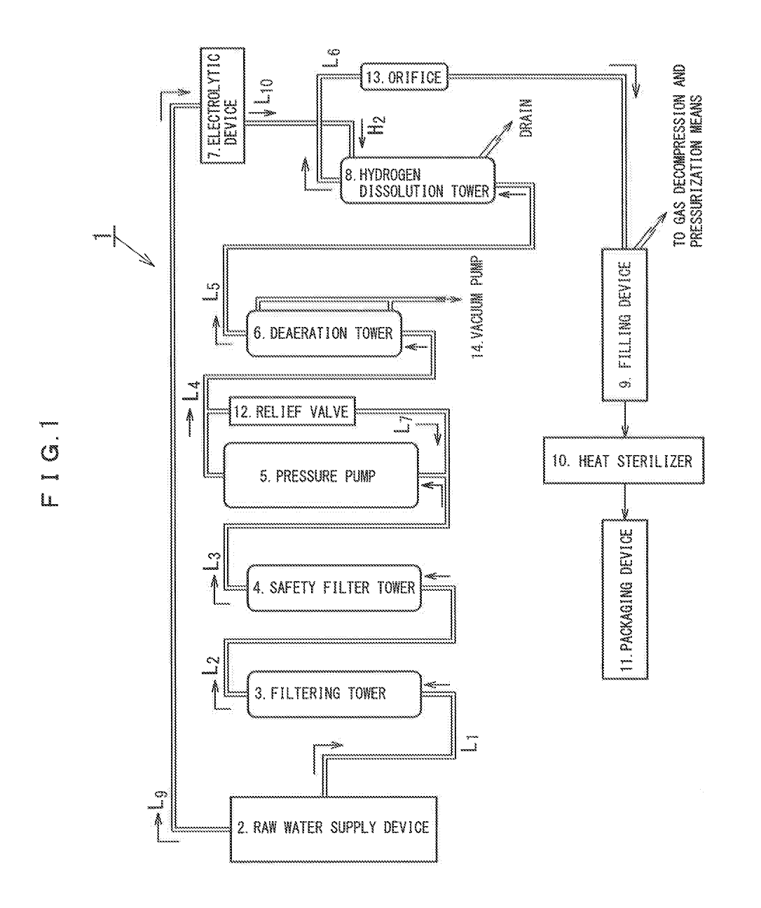

An aspect of an apparatus for manufacturing hydrogen-containing drinking water, which can be used in a method of manufacturing hydrogen-containing drinking water of the invention, is illustrated in FIG. 1.

This manufacturing apparatus 1 mainly includes a raw water supply device 2, a filtering tower 3, a safety filter tower 4, a pressure pump 5, a deaeration tower 6, an electrolytic device 7, a hydrogen dissolution tower 8, a filling device 9, a relief valve 12, and an orifice 13. The deaeration tower 6 corresponds to the above-mentioned deaeration device (a), and the hydrogen dissolution tower 8 corresponds to the hydrogen dissolution device (b).

First, the entirety of the flow of water (raw water, purified water, deaerated water, and hydrogen-containing water) in this manufacturing apparatus will be described.

As illustrated in FIG. 1, water, which is supplied from the raw water supply device 2 and is used as a raw material, is supplied to the filtering tower 3, which is filled with an activated carbon layer, through a pipe L1, and is dichlorinated by being subjected to activated carbon treatment in the filtering tower 3.

Next, water, which is discharged from the filtering tower 3, is sent to the safety filter tower 4, in which an MF film is installed, through a pipe L2.

Then, purified water, which is discharged from the safety filter tower 4, is sent to the pressure pump 5 through a pipe L3.

The pressure pump 5 functions to apply pressure to water flow channels (L4 to L6) corresponding to hydrogen-containing water, which is to be injected to a packaging container with a spout to be described below, from the purified water that is discharged from the safety filter tower 4 (purified water to be supplied to the deaeration tower 6); and can transport hydrogen-containing water, of which dissolved hydrogen concentration is high, to the filling device through water flow channels by applying pressure, which is much higher than pressure in the related art, (for example, reference pressure after the adjustment of pressure performed by a loop flow channel and a relief valve to be described below: 0.1 MPa to 0.5 MPa) to water that is to be changed to hydrogen-containing water from the purified water.

Subsequently, purified water, which is discharged from the pressure pump 5, is sent to the deaeration tower 6 through the pipe L4. Meanwhile, as described below, a part of the purified water, which is discharged from the pressure pump 5, returns to the pressure pump 5 through the pipe L7 (a loop flow channel), that is, a circulating flow can t e formed at a normal time. Further, the relief valve 12 is installed on the pipe L7, and the operation of water circulation/the stop of water circulation through the pipe L7 of the loop flow channel is performed by the opening and closing of the relief valve 12.

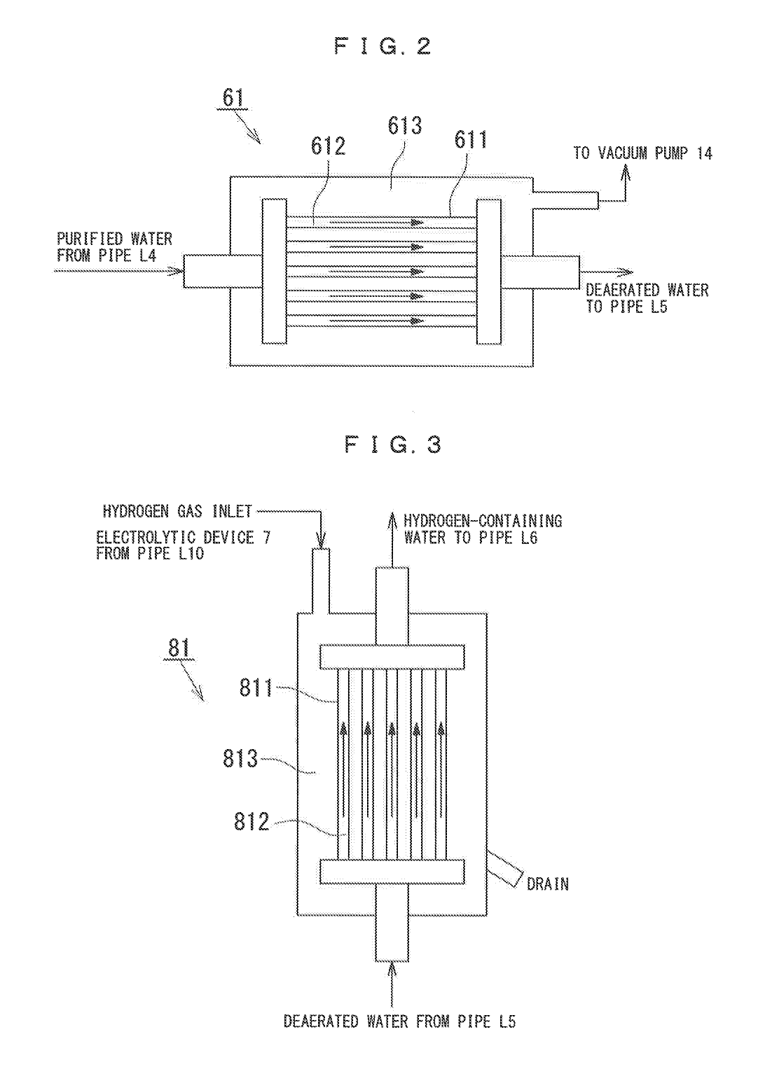

A hollow fiber membrane module 61 is installed in the deaeration tower 6, and the hollow fiber membrane module 61 is partitioned into water chambers 612 and a gas chamber 613 by hollow fiber membranes 611 as illustrated in FIG. 2. Then, when the decompression of the gas chamber 613 is maintained by a vacuum pump 14, gas (oxygen gas, nitrogen gas, carbon dioxide, or the like) dissolved in the purified water, which flows in the water chambers 612, penetrates the hollow fiber membranes 611 and is moved to the gas chamber 613. Accordingly, purified water, which flows in the water chambers 612, is deaerated.

Deaerated water from which dissolved gas has been removed is sent to the hydrogen dissolution tower 8, in which a hollow fiber membrane module 81 is installed, through the pipe L5.

The hollow fiber membrane module 81 is partitioned into water chambers 812 and a gas chamber 813 by hollow fiber membranes 811 as illustrated in FIG. 3. Then, hydrogen gas, which is manufactured by the electrolytic device 7, is supplied to the gas chamber 813 through a pipe L10. Water, which is to be supplied to the electrolytic device 7, is supplied from the raw water supply device 2 through a pipe L9.

Further, in the hollow fiber membrane module 81, hydrogen gas supplied from the electrolytic device 7 is pressurized and is sent to the gas chamber 813. Accordingly, hydrogen gas penetrates the hollow fiber membrane 811 due to partial pressure difference and is supplied to deaerated water flowing in the water chambers 812. As a result, hydrogen-containing water is manufactured.

Hydrogen-containing water, which is obtained in this way, is supplied to the filling device 9 through the pipe L6 while the high pressure applied to the hydrogen-containing water is maintained. Meanwhile, as described below, the pipe L6, which extends to the filling device 9 from the hydrogen dissolution tower 8, is provided with the orifice 13 that adjusts the flow rate of the hydrogen-containing water. Further, in the filling device 9, hydrogen-containing water is injected and filled into the packaging container from an injection port of the packaging container with a spout. Then, the injection port of the container is sealed. Subsequently, a water product, which is sealed in the packaging container with a spout, is subjected to heat sterilization in a heat sterilizer 10. The heat sterilization is performed by heating treatment for 30 minutes at 85° C. in accordance with a rule of a food sanitation law. Lastly, the water product, which has been subjected to heat sterilization, is packaged by a packaging device 11.

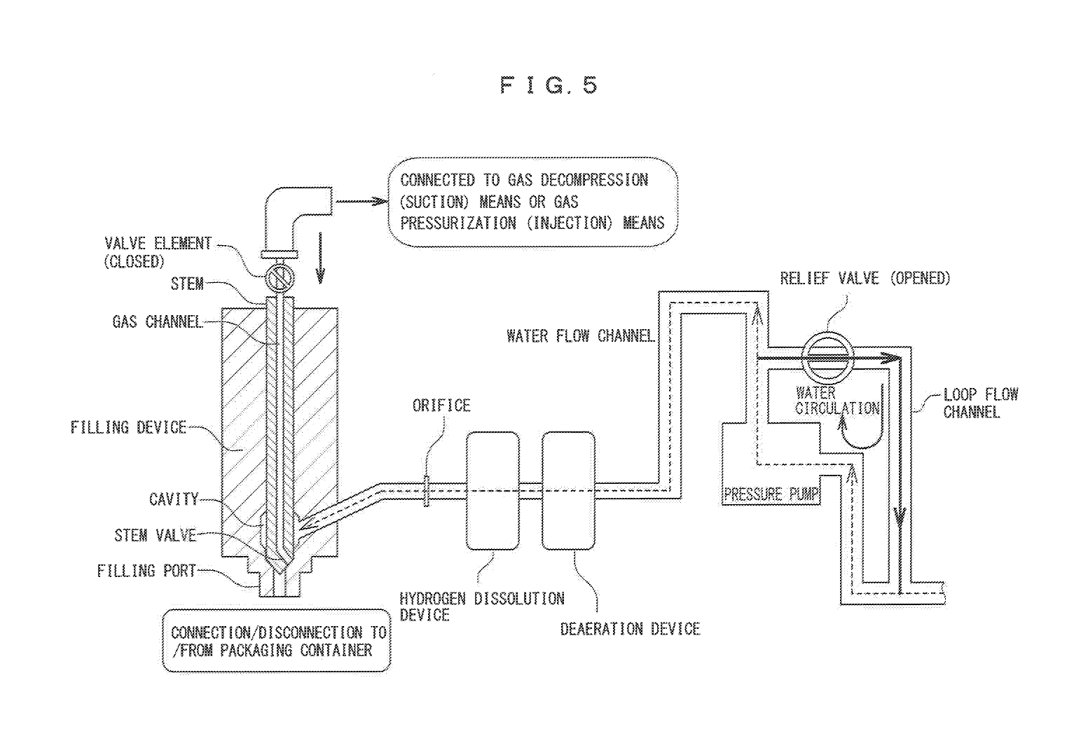

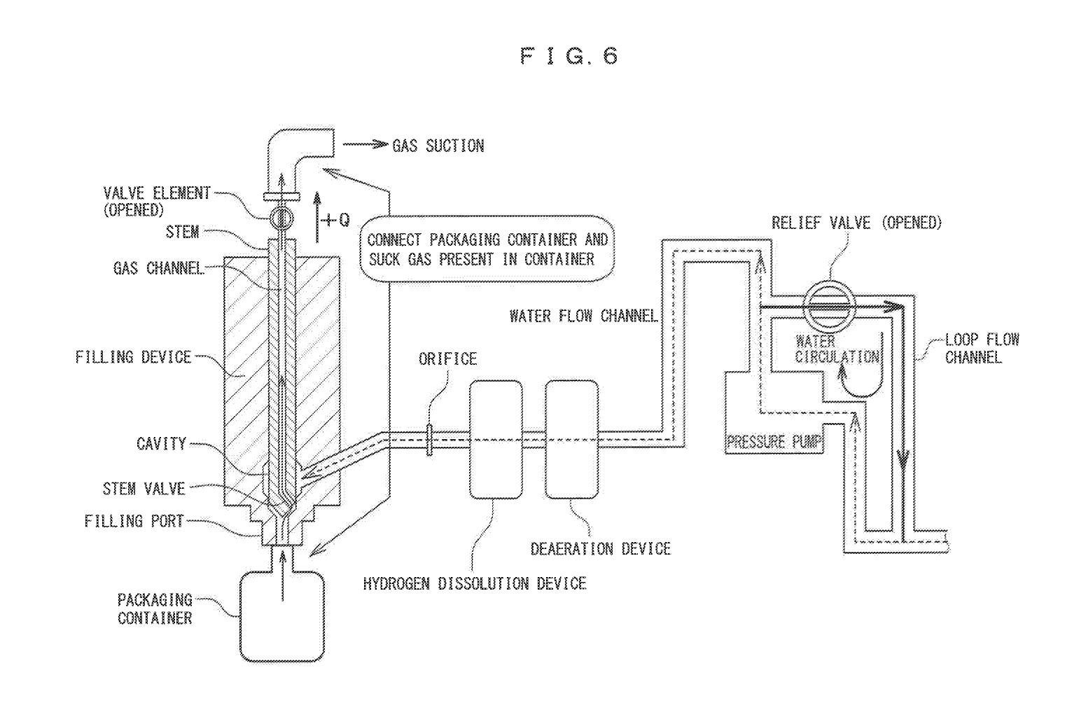

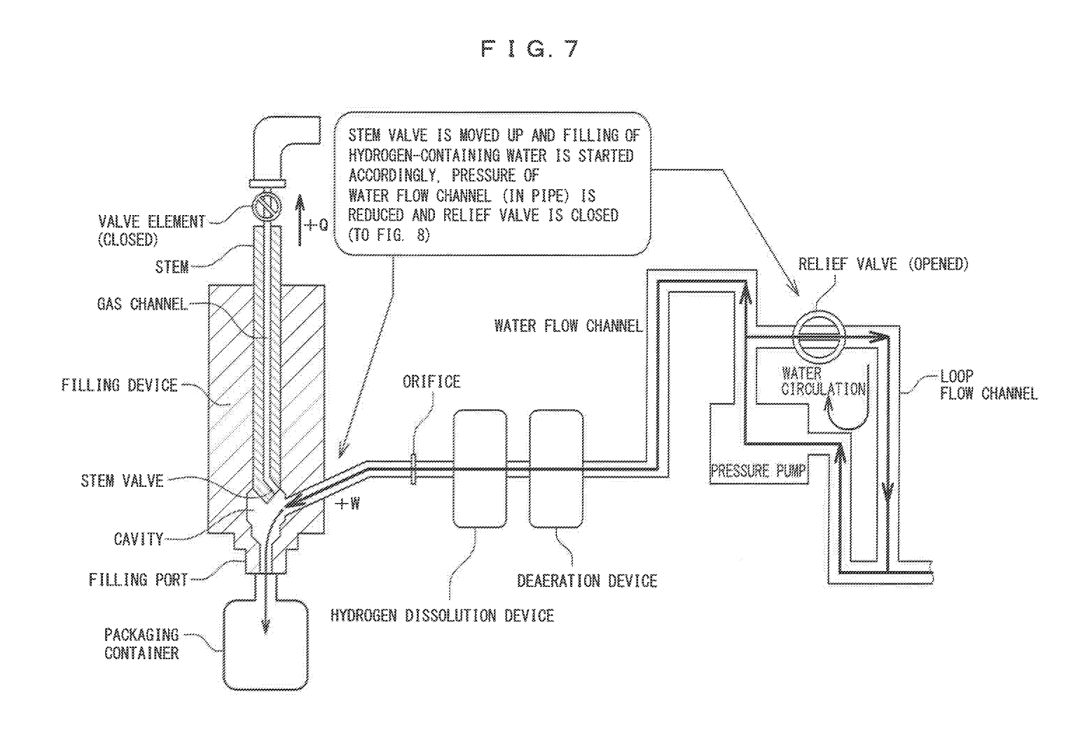

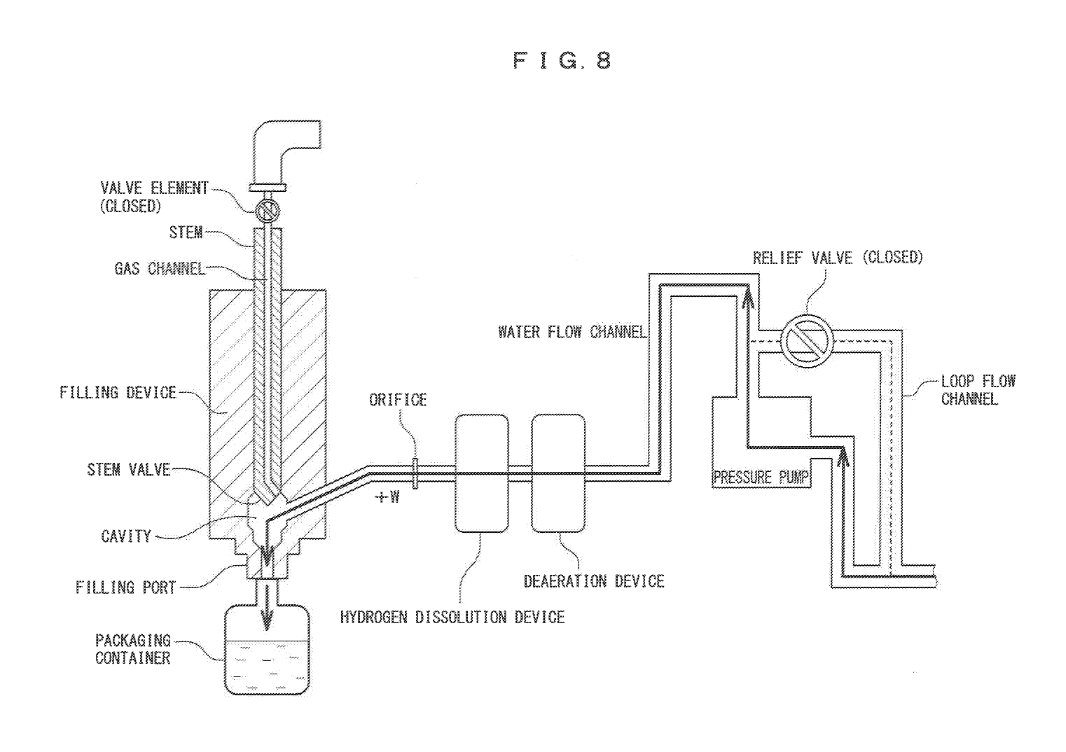

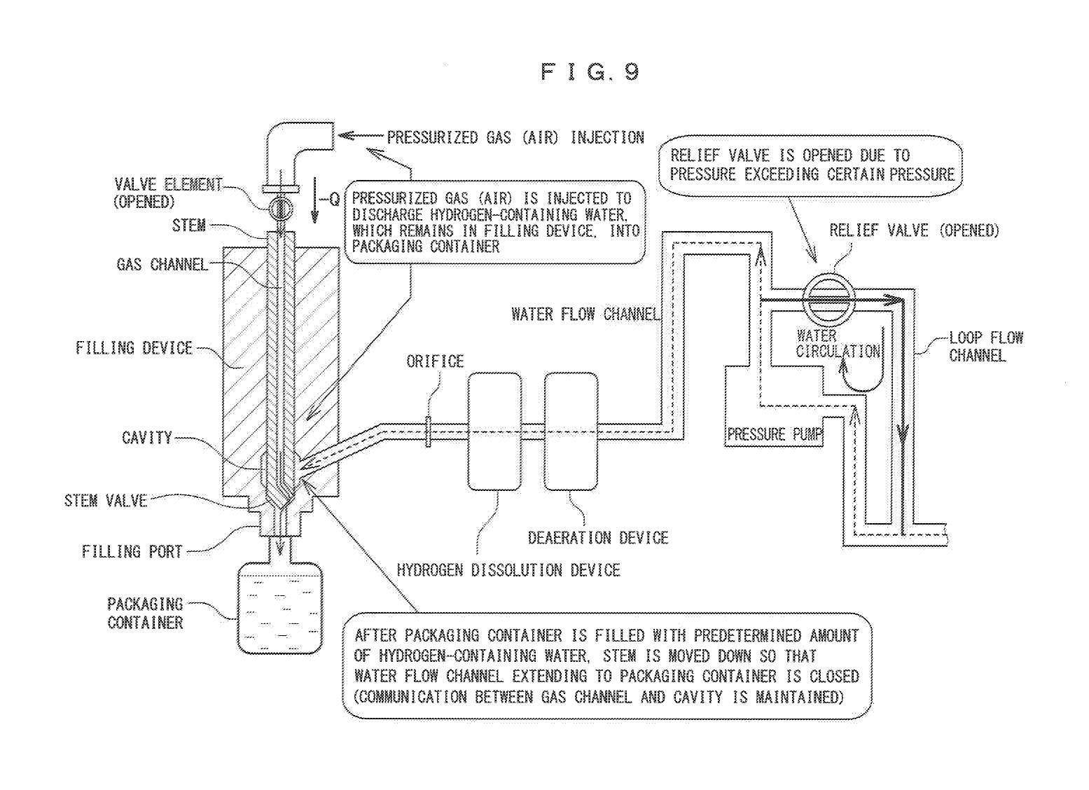

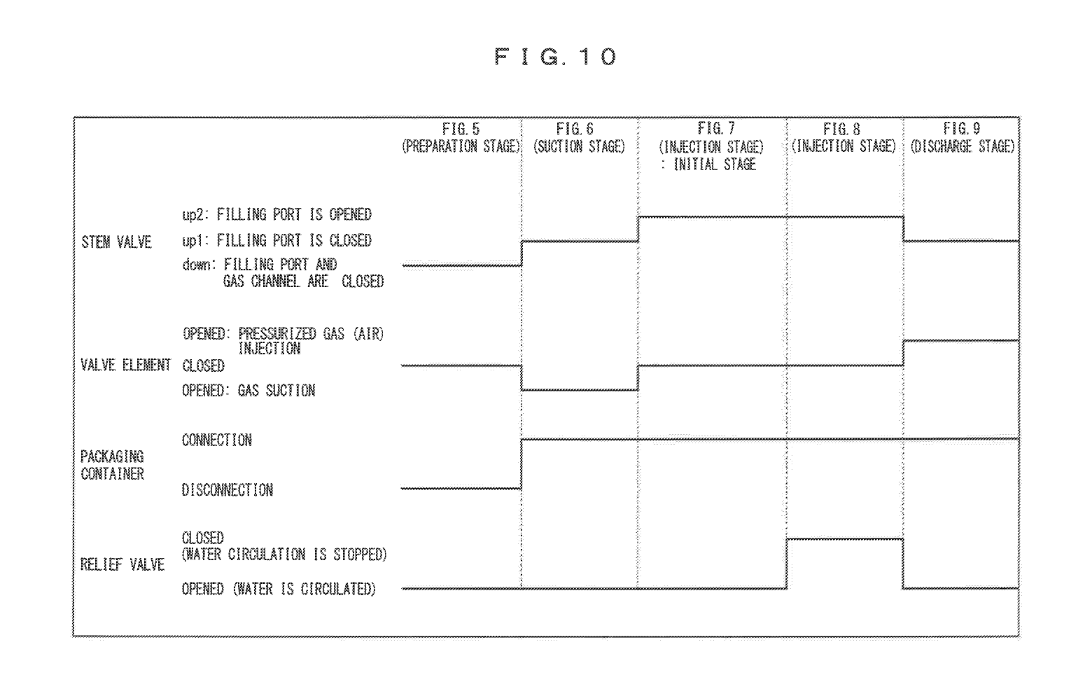

FIGS. 5 to 9 are diagrams illustrating the detail of the flow of water after the pressure pump in the apparatus for manufacturing hydrogen-containing drinking water that can be used in the manufacturing method of the invention, that is, diagrams illustrating every stage of a step of filling the packaging container with a spout with hydrogen-containing water (FIG. 5: a preparation stage, FIG. 6: a deaeration stage, FIG. 7 and FIG. 8: an injection stage, and FIG. 9: a discharge stage).

Further, FIG. 10 illustrates a flow diagram illustrating the reciprocation of a stem valve of the filling device, the opening and closing of a valve element of the stem valve, the connection/disconnection of the packaging container to/from the filling device, and the opening and closing of the relief valve of the loop flow channel in the stages, which are illustrated in FIGS. 5 to 9 to be described below, of the filling step in the apparatus for manufacturing hydrogen-containing drinking water that can be used in the manufacturing method of the invention.

Meanwhile, the loop flow channel is provided so that the water flow channel to which pressure has been applied by the pressure pump communicates with the water flow channel to which pressure is not yet applied as illustrated in FIGS. 5 to 9. Further, the loop flow channel is provided with the relief valve that operates so as to be opened when the water pressure of the water flow channel exceeds a certain reference pressure and so as to maintain a state in which the relief valve is closed while the water pressure of the water flow channel is lower than the certain reference pressure.

Furthermore, the orifice for adjusting a flow rate is provided between the hydrogen dissolution device and the filling device.

Moreover, the filling device includes a cavity that is formed in a device body and is connected to a filling port, and includes the stem valve that can reciprocate (move up and down in the drawings) so that the tip portion of the stem valve faces the filling port; and the reciprocation of the stem valve is periodically repeated. In addition, the cavity communicates with the water flow channel extending from the hydrogen dissolution device; and the injection port of the packaging container, which is connected to the filling port, is allowed to communicate with the water flow channel extending from the hydrogen dissolution device and the communication of the injection port is blocked by the reciprocation of the stem valve, that is, the opening and closing of the filling port can be performed.

Further, the cavity is connected to gas decompression means (gas suction means) and gas pressurization means (gas injection means) through a gas channel formed in the stem valve, and the gas channel is adapted to be opened and closed by the reciprocation of the stem valve (the up-and-down movement in the drawings).

First, as illustrated in FIG. 5, in the preparation stage of the filling step, the stem valve closes the filling port of the filling device and hydrogen-containing water to which pressure is applied is supplied into the cavity connected to the filling port from the hydrogen dissolving step. In this stage, the manufactured hydrogen-containing water remains in the cavity of the filling device. Accordingly, in order to make the water pressure of the water flow channel, to which pressure has been applied by the pressure pump, constant, the relief valve functions to open the loop flow channel when the water pressure exceeds the reference pressure. As a result, water is circulated between the pressure pump and the loop flow channel.

Meanwhile, FIG. 5 illustrates a state in which the stem valve closes both the filling port and the gas channel, but the stem valve only has to close at least the filling port in this stage and may open the gas channel as illustrated in FIG. 6.

Next, in the deaeration stage illustrated in FIG. 6, the injection port of the packaging container with a spout is connected to the filling port of the filling device. The stem valve still closes the filling port (the water flow channel extending from the hydrogen dissolution device and the injection port of the packaging container do not yet communicate with each other), but the gas channel formed in the stem valve communicates with the cavity, that is, the gas charnel is opened (the stem valve is slightly moved in a +Q direction in FIG. 6). Then, the valve element, which is provided at an upper portion of the stem valve, is opened, and gas present in the packaging container is removed through the gas channel, which is formed in the stem valve, by the gas decompression means (not illustrated). In this stage, water is still circulated between the pressure pump and the loop flow channel.

After that, in the injection stage illustrated in FIGS. 7 and 8, first, the valve element, which is provided at the upper portion of the stem valve, is closed to block the communication between the gas channel and the outside. Then, the stem valve is sufficiently moved (the stem valve is further moved in the +Q direction in FIGS. 7 and 8) so that the filling port is opened, that is, the water flow channel extending from the hydrogen dissolution device and the injection port of the packaging container communicate with each other and hydrogen-containing water is directly injected into the packaging container (hydrogen-containing water flows in a +W direction in FIGS. 7 and 8).

Meanwhile, as illustrated in FIGS. 7 and 8, the orifice is provided between the hydrogen dissolution device and the filling device, and the flow rate of hydrogen-containing water, which is supplied from the hydrogen dissolution device and to which the reference pressure is applied, is limited to a certain reference flow rate or less by the orifice. Accordingly, hydrogen-containing water can be smoothly and safely injected into the packaging container.

Further, water is circulated between the pressure pump and the loop flow channel at the beginning (FIG. 7) of the injection stage. However, the water pressure of the water flow channel, to which pressure has been applied, is reduced from the reference pressure when hydrogen-containing water starts to be injected. Then, the relief valve connected to the loop flow channel is closed during the reduction of pressure, so that water circulation stops (FIG. 8).

After that, the step proceeds to the discharge stage illustrated in FIG. 9 after a considerable amount of hydrogen-containing water is filled into the packaging container in the injection stage. In this stage, the stem valve blocks the communication between the water flow channel, which extends from the hydrogen dissolution device, and the injection port of the packaging container, but maintains the communication between the gas channel, which is formed in the stem valve, and the cavity, that is, closes the filling port and opens the gas channel (the stem valve is slightly moved in a −Q direction in FIG. 9). In this case, the manufactured hydrogen-containing water remains in the cavity of the filling device. Meanwhile, when the water pressure of the water flow channel exceeds the reference pressure, the relief valve functions to open the loop flow channel again. As a result, water is circulated between the pressure pump and the loop flow channel.

After that, the valve element, which is provided at the upper portion of the stem valve, is opened so that pressurized air is introduced into the cavity through the gas channel formed in the stem valve by gas pressurization means (not illustrated). Accordingly, hydrogen-containing water remaining in the filling device is discharged into the packaging container. Therefore, the amount of hydrogen-containing water to be filled into the packaging container is maintained constant.

Lastly, the injection port of the packaging container and the filling port of the filling device are disconnected from each other (returning to FIG. 5), and the injection port of the packaging container, which is completely filled with hydrogen-containing water, is immediately sealed by a sealing device (not illustrated).

### Example 1 and Example 2

A water product, which is filled with hydrogen-containing drinking water manufactured by the method of manufacturing hydrogen-containing drinking water of the invention, was manufactured using tap water as a raw material of purified water by the manufacturing apparatus illustrated in FIG. 1 (to FIG. 3) and the filling method illustrated in FIGS. 5 to 9.

In this example, the pressure of hydrogen gas to be supplied to the hydrogen dissolution device was set to the range of 0.25 MPa to 0.3 MPa (a pressure higher than atmospheric pressure by pressure in the range of 0.25 MPa to 0.3 MPa). Further, reference pressure to be applied to the water flow channels corresponding to hydrogen-containing water, which is to be injected into the packaging container in the filling device, from the purified water, which is to be supplied to the deaeration device, was set to 0.3 MPa (pressure higher than atmospheric pressure by a pressure of 0.3 MPa). Meanwhile, when the water pressure of the water flow channel exceeded the reference pressure (0.3 MPa), the relief valve was opened and started to circulate water between the loop flow channel and the pressure pump, and the water pressure was maintained at a reference pressure value. On the other hand, when the water pressure was lower than the reference pressure during the filling of hydrogen-containing water to the packaging container, the relief valve was closed and stopped circulating water. Furthermore, in this example, an orifice of 6φ was employed to adjust the flow rate of hydrogen-containing water to be supplied to the filling device and the reciprocation of the stem valve was performed at a rate of 70 shot/min (in a case of a container having a volume of 150 mL to be described below) and a rate of 20 shot/min (in a case of a container having a volume of 500 mL to be described below). Moreover, after the packaging container is filled with a predetermined amount of hydrogen-containing water, pressure applied to the water flow channel to which pressure had been applied was about 0.2 MPa (a state in which pressure higher than atmospheric pressure by about 0.2 MPa was applied to the water flow channel).

Further, a packaging container with a spout having a volume of 150 mL was used as the packaging container with a spout in Example 1, and a packaging container with a spout having a volume of 500 mL was used as the packaging container with a spout in Example 2.

Meanwhile, the dissolved hydrogen concentration of hydrogen-containing water was about 2.6 ppm (2.4 ppm to 2.8 ppm) at room temperature under atmospheric pressure. The above-mentioned dissolved hydrogen concentration is the dissolved hydrogen concentration of hydrogen-containing water when the packaging container is not yet subjected to heat sterilization (for 30 minutes at 85° C.) after being filled with hydrogen-containing water.

### Comparative Example

### Method of Manufacturing Hydrogen-Containing Drinking Water in the Related Art

Hydrogen-containing drinking water of Comparative Example was manufactured by a manufacturing method based on a method disclosed in JP 2010-269246 A.

Specifically, hydrogen-containing water was manufactured by a method including: (1) a purification step of filtering and purifying water as a raw material in a purification device and sending obtained purified water to a deaeration device: (2) a deaeration step of deaerating the purified water supplied to the deaeration device and sending obtained deaerated water to a hydrogen dissolution device; (3) a hydrogen dissolving step of dissolving hydrogen gas in the deaerated water supplied to the hydrogen dissolution device and sending obtained hydrogen-dissolved water to a sterilizer; (4) a sterilization step of sterilizing the hydrogen-dissolved water supplied to the sterilizer and sending obtained hydrogen-containing water to a filling device; (5) a filling step of filling a sealed container with the hydrogen-containing water supplied to the filling device and sending a filled water product to a heat sterilizer: and (6) a heat sterilization step of heat ing and sterilizing the water product sent to the heat sterilizer. The hydrogen dissolution device includes a gas permeable membrane module that is partitioned into a water chambers and a gas chamber by gas permeable membranes. The gas permeable membrane module dissolves hydrogen gas in the deaerated water by allowing the deaerated water to permeate the water chambers, and pressurizing hydrogen gas and supplying the hydrogen gas to the gas chamber.

### Comparative Example 1 and Comparative Example 2

A packaging container was filled with obtained hydrogen-containing water by a filling method in the related art illustrated in FIGS. 4 (a) and 4(b). As a result, a water product of Comparative Example was manufactured. That is, first, manufacturing hydrogen-containing water was temporarily stored in a hydrogen-containing water tank, and a piston of a measuring device connected to the hydrogen-containing water tank was moved down to measure a predetermined amount of hydrogen-containing water. Meanwhile, as illustrated in FIG. 4(a), gas remaining in the packaging container was removed by suction through the gas channel formed in a stem valve of the filling device before the filling of the hydrogen-containing water was started.

After that, the stem valve of the filling device and the piston of the measuring device were moved up in synchronization with each other, so that the packaging container was filled with the hydrogen-containing water through the filling port.

Lastly, an injection port of the packaging container with a spout was sealed so that a water product was formed. Subsequently, the water product was subjected to heat sterilization (for 30 minutes at 85° C.) by the heat sterilizer.

Meanwhile, as the packaging container, the packaging container with a spout having a volume of 150 mL was used in Comparative Example 1 and the packaging container with a spout having a volume of 500 mL was used in Comparative Example 2.

Further, the dissolved hydrogen concentration of the hydrogen-containing water according to this example was about 1.5 ppm at room temperature under atmospheric pressure. The dissolved hydrogen concentration is the dissolved hydrogen concentration of hydrogen-containing water when the packaging container is not yet subjected to heat sterilization (for 30 minutes at 85° C.) after being filled with hydrogen-containing water.

<Change with Time of Dissolved Hydrogen Concentration>

The water product in which the packaging container was filled with hydrogen-containing drinking water manufactured by the manufacturing method in the related art (Comparative Example), and the water product in which the packaging container was filled with hydrogen-containing drinking water manufactured by the manufacturing method of the invention (Example) were kept for a predetermined time. Dissolved hydrogen concentration, pH, and an oxidation-reduction potential (vs. Ag/AgCl) were measured when 60 days, 90 days, 120 days, 150 days, and 180 days had elapsed (water products were stored at 25° C.±5° C.) after the manufacture of the water product. Meanwhile, five water products were produced for each elapsed period, and measurement results were derived as average values thereof.

Tables 1 to 3 show a change in dissolved hydrogen concentration dH, a change in pH, and a change in oxidation-reduction potential ORP that were measured from Examples 1 and 2 and Comparative Examples 1 and 2.

Meanwhile, saturated hydrogen concentration at 20° C. under one atmosphere was 1.6 ppm.

TABLE 1

| | Product volume | | Product volume | |
|---|---|---|---|---|
| Dissolved hydrogen | 150 mL | | 500 mL | |
| concentration dH | | Comparative | | Comparative |
| (ppm) | Example 1 | Example 1 | Example 2 | Example 2 |
| 60 day-elapsed | 1.39 | 0.86 | 1.54 | 0.93 |
| product | | | | |
| 90 day-elapsed | 1.31 | 0.63 | 1.49 | 0.75 |
| product | | | | |
| 120 day-elapsed | 1.26 | 0.33 | 1.45 | 0.48 |
| product | | | | |
| 150 day-elapsed | 1.15 | 0.18 | 1.37 | 0.35 |
| product | | | | |
| 180 day-elapsed | 1.03 | 0.08 | 1.32 | 0.22 |
| product | | | | |

TABLE 2

| | Product volume 150 mL | | Product volume 500 mL | |
|---|---|---|---|---|
| | | Comparative | | Comparative |
| pH | Example 1 | Example 1 | Example 2 | Example 2 |
| 60 day-elapsed | 6.96 | 6.96 | 7.08 | 7.09 |
| product | | | | |
| 90 day-elapsed | 6.92 | 6.67 | 7.06 | 7.09 |
| product | | | | |
| 120 day-elapsed | 6.92 | 6.67 | 7.09 | 7.13 |
| product | | | | |
| 150 day-elapsed | 6.92 | 6.68 | 7.06 | 7.12 |
| product | | | | |
| 180 day-elapsed | 6.91 | 6.65 | 7.05 | 7.12 |
| product | | | | |

TABLE 3

| | Product volume | | Product volume | |
|---|---|---|---|---|
| | 150 mL | | 500 mL | |
| Oxidation-reduction | | Comparative | | Comparative |
| potential ORP (mV) | Example 1 | Example 1 | Example 2 | Example 2 |
| 60 day-elapsed | −609 | −584 | −620 | −608 |
| product | | | | |
| 90 day-elapsed | −607 | −577 | −616 | −598 |
| product | | | | |
| 120 day-elapsed | −606 | 176 | −617 | −481 |
| product | | | | |
| 150 day-elapsed | −604 | 251 | −613 | 122 |
| product | | | | |
| 180 day-elapsed | −602 | 273 | −610 | 229 |
| product | | | | |

As shown in Tables 1 and 3, in the case of the water products of Examples according to the invention, high dissolved hydrogen concentration was maintained even after the elapse of 180 days and an oxidation-reduction potential was also maintained at a low value. Accordingly, hydrogen-containing water could be maintained at high quality by the manufacturing method of the invention even after being stored for a long time.

On the other hand, in the case of the water products of Comparative Examples, dissolved hydrogen concentration was already lower than 1.0 ppm at the time of the elapse of 60 days, and an oxidation-reduction potential was changed to a positive value after the elapse of 120 days in the case of the water product (Comparative Example 1) having a volume of 150 mL and after the elapse of 150 days in the case of the water product (Comparative Example 2) having a volume of 500 mL.

These results supported the fact that the quality of hydrogen-containing water could be maintained at a high value until the time of actual consumption (intake) in the manufacturing method of the invention, considering a storage period until products were actually distributed and consumed, and the quality of hydrogen-containing water deteriorates during the storage period in the manufacturing method in the related art.

Since the manufacturing method of the invention employs the above-mentioned structure as described above, it is possible to increase the dissolved hydrogen concentration of hydrogen-containing water to be obtained and to reduce dissolved oxygen concentration. Particularly, it is possible to fill the packaging container with hydrogen-containing water while suppressing the change of the dissolved hydrogen concentration of hydrogen-containing water to a low level.

Further, since the manufacturing apparatus of the invention is suitable for the highly efficient use of the manufacturing method of the invention, the effect of the manufacturing method of the invention can be sufficiently obtained.

### REFERENCE SIGNS LIST

1: apparatus for manufacturing hydrogen-containing drinking water
2: raw water supply device
3: filtering tower
4: safety filter tower
5: pressure pump
6: deaeration tower
61: hollow fiber membrane module
611: hollow fiber membrane
612: water chamber
613: gas chamber
7: electrolytic device
8: hydrogen dissolution tower
81: hollow fiber membrane module
811: hollow fiber membrane
812: water chamber
813: gas chamber
9: filling device
10: heat sterilizer
11: packaging device
12: relief valve
13: orifice
14: vacuum pump
L1 to L7: pipe

1. An apparatus for continuously manufacturing hydrogen-containing drinking water, the apparatus comprising:
(a) a deaeration device that deaerates purified water of a supplied raw material through a hollow fiber membrane;
(b) a hydrogen dissolution device that dissolves pressurized hydrogen gas in deaerated water, which is supplied from the deaeration device, through the hollow fiber membrane;
(c) a filling device that fills a packaging container with a spout from an injection port of the packaging container with hydrogen-containing water supplied from the hydrogen dissolution device;
(d) a sealing device that seals the injection port of the packaging container with a spout completely filled with the hydrogen-containing water;
a pressure pump that is capable of applying pressure to water flow channels corresponding to the hydrogen-containing water, which is to be injected to the packaging container by the filling device (c), from the purified water that is to be supplied to the deaeration device (a);
a relief valve that is connected to a loop flow channel allowing the water flow channel, to which pressure has been applied by the pressure pump, to communicate with the water flow channel to which pressure is not yet applied, closes the loop flow channel when water pressure of the water flow channel to which pressure has been applied is lower than a certain reference pressure, and opens the loop flow channel when the water pressure exceeds the certain reference pressure; and
an orifice that is connected to the water flow channel provided ahead of the filling device (c) and limits the flow rate of hydrogen-containing water, to which the reference pressure is applied and which is to be supplied to the filling device (c), to a certain reference flow rate or less,
wherein the filling device (c) includes a cavity that is formed in a device body and is connected to a filling port, and includes a stem valve that is capable of reciprocating so that a tip portion of the stem valve faces the filling port,
the cavity communicates with the water flow channel extending from the hydrogen dissolution device (b),
the stem valve is a valve mechanism that allows the injection port of the packaging container, which is connected to the filling port, to communicate with the water flow channel extending from the hydrogen dissolution device (b) and blocks the communication of the injection port by the reciprocation thereof,
the cavity is connected to gas decompression means and gas pressurization means through a gas channel that is formed in the stem valve or formed along an outer surface of the stem valve, and
the gas channel is adapted to be opened and closed by the reciprocation of the stem valve.

2. The apparatus for manufacturing hydrogen-containing drinking water according to claim 1,
wherein the reference pressure is in the range of 0.1 MPa to 0.5 MPa.

3. A method of continuously manufacturing hydrogen-containing drinking water, the method comprising:
(A) a deaeration step of deaerating purified water of a supplied raw material through a hollow fiber membrane in a deaeration device and sending obtained deaerated water to a hydrogen dissolution device;
(B) a hydrogen dissolving step of dissolving pressurized hydrogen gas in the supplied deaerated water through a hollow fiber membrane in the hydrogen dissolution device and sending obtained hydrogen-containing water to a filling device;
(C) a filling step of filling a packaging container with a spout from an injection port of the packaging container with the supplied hydrogen-containing water in the filling device; and
(D) a sealing step of sealing the injection port of the packaging container with a spout filled with the hydrogen-containing water,
the hydrogen-containing water to which pressure is applied being supplied to the filling device, by applying pressure to water flow channels corresponding to the hydrogen-containing water, which is to be injected to the packaging container in the filling step (C), from the purified water, which is to be supplied to the deaeration device in the deaeration step (A), by the operation of a pressure pump,
wherein the filling step (C) includes
a preparation stage of making a state in which a stem valve closes a filling port of the filling device and the hydrogen-containing water to which pressure applied from the hydrogen dissolving step (B) is applied is supplied into a cavity connected to the filling port,
a deaeration stage of connecting the injection port of the packaging container to the filling port and subsequently removing gas, which is present in the packaging container, through a gas channel of the stem valve by gas decompression means,
an injection stage of closing the gas channel, allowing the stem valve to open the filling port, and directly injecting the hydrogen-containing water, to which pressure is applied, into the packaging container, and
a discharge stage of discharging hydrogen-containing water, which remains in the filling device, into the packaging container by opening the gas channel and introducing pressurized air into the cavity through the gas channel by gas pressurization means after the stem valve closes the filling port, and
the method comprises:
a step of immediately proceeding to the sealing step (D) when the injection port and the filling port are disconnected from each other.

4. The method of manufacturing hydrogen-containing drinking water according to claim 3,
wherein when water pressure of the water flow channel to which pressure has been applied by the pressure pump exceeds a certain reference pressure, a relief valve connected to a loop flow channel extending to the water flow channel, to which pressure is not yet applied, from the water flow channel to which pressure has been applied is opened so that hydrogen-containing water, to which the reference pressure is applied, is capable of being stably supplied to the filling device.

5. The method of manufacturing hydrogen-containing drinking water according to claim 3,
wherein an operation of the stem valve for opening and closing the filling port is periodically repeated in the filling step (C), and
the flow rate of the hydrogen-containing water, which is supplied to the filling device from the hydrogen dissolving step (B) and to which the reference pressure is applied, is limited to a certain reference flow rate or less by an orifice.

6. The method of manufacturing hydrogen-containing drinking water according to claim 3,
wherein an apparatus for manufacturing hydrogen-containing drinking water is used and comprises
(a) a deaeration device that deaerates purified water of a supplied raw material through a hollow fiber membrane;
(b) a hydrogen dissolution device that dissolves pressurized hydrogen gas in deaerated water, which is supplied from the deaeration device, through the hollow fiber membrane;
(c) a filling device that fills a packaging container with a spout from an injection port of the packaging container with hydrogen containing water supplied from the hydrogen dissolution device;
(d) a sealing device that seals the injection port of the packaging container with a spout completely filled with the hydrogen-containing water;
a pressure pump that is capable of applying pressure to water flow channels corresponding to the hydrogen-containing water, which is to be injected to the packaging container by the filling device (c), from the purified water that is to be supplied to the deaeration device (a);
a relief valve that is connected to a loop flow channel allowing the water flow channel, to which pressure has been applied by the pressure pump, to communicate with the water flow channel to which pressure is not yet applied, closes the loop flow channel when water pressure of the water flow channel to which pressure has been applied is lower than a certain reference pressure, and opens the loop flow channel when the water pressure exceeds the certain reference pressure; and
an orifice that is connected to the water flow channel provided ahead of the filling device (c) and limits the flow rate of hydrogen-containing water, to which the reference pressure is applied and which is to be supplied to the filling device (c), to a certain reference flow rate or less,
wherein the filling device (c) includes a cavity that is formed in a device body and is connected to a filling port, and includes a stem valve that is capable of reciprocating so that a tip portion of the stem valve faces the filling port,
the cavity communicates with the water flow channel extending from the hydrogen dissolution device (b),
the stem valve is a valve mechanism that allows the injection port of the packaging container, which is connected to the filling port, to communicate with the water flow channel extending from the hydrogen dissolution device (b) and blocks the communication of the injection port by the reciprocation thereof,
the cavity is connected to gas decompression means and gas pressurization means through a gas channel that is formed in the stem valve or formed along an outer surface of the stem valve, and
the gas channel is adapted to be opened and closed by the reciprocation of the stem valve.

7. The method of manufacturing hydrogen-containing drinking water according to claim 3,
wherein the reference pressure is in the range of 0.1 MPa to 0.5 MPa.

8. The method of manufacturing hydrogen-containing drinking water according to claim 4,
wherein an operation of the stem valve for opening and closing the filling port is periodically repeated in the filling step (C), and
the flow rate of the hydrogen-containing water, which is supplied to the filling device from the hydrogen dissolving step (B) and to which the reference pressure is applied, is limited to a certain reference flow rate or less by an orifice.

9. The method of manufacturing hydrogen-containing drinking water according to claim 4,
wherein an apparatus for manufacturing hydrogen-containing drinking water is used and comprises
(a) a deaeration device that deaerates purified water of a supplied raw material through a hollow fiber membrane;
(b) a hydrogen dissolution device that dissolves pressurized hydrogen gas in deaerated water, which is supplied from the deaeration device, through the hollow fiber membrane;
(c) a filling device that fills a packaging container with a spout from an injection port of the packaging container with hydrogen-containing water supplied from the hydrogen dissolution device;
(d) a sealing device that seals the injection port of the packaging container with a spout completely filled with the hydrogen-containing water;
a pressure pump that is capable of applying pressure to water flow channels corresponding to the hydrogen-containing water, which is to be injected to the packaging container by the filling device (c), from the purified water that is to be supplied to the deaeration device (a);
a relief valve that is connected to a loop flow channel allowing the water flow channel, to which pressure has been applied by the pressure pump, to communicate with the water flow channel to which pressure is not yet applied, closes the loop flow channel when water pressure of the water flow channel to which pressure has been applied is lower than a certain reference pressure, and opens the loop flow channel when the water pressure exceeds the certain reference pressure; and
an orifice that is connected to the water flow channel provided ahead of the filling device (c) and limits the flow rate of hydrogen-containing water, to which the reference pressure is applied and which is to be supplied to the filling device (c), to a certain reference flow rate or less,
wherein the filling device (c) includes a cavity that is formed in a device body and is connected to a filling port, and includes a stem valve that is capable of reciprocating so that a tip portion of the stem valve faces the filling port,
the cavity communicates with the water flow channel extending from the hydrogen dissolution device (b),
the stem valve is a valve mechanism that allows the injection port of the packaging container, which is connected to the filling port, to communicate with the water flow channel extending from the hydrogen dissolution device (b) and blocks the communication of the injection port by the reciprocation thereof,
the cavity is connected to gas decompression means and gas pressurization means through a gas channel that is formed in the stem valve or formed along an outer surface of the stem valve, and
the gas channel is adapted to be opened and closed by the reciprocation of the stem valve.

10. The method of manufacturing hydrogen-containing drinking water according to claim 5,
wherein an apparatus for manufacturing hydrogen-containing drinking water is used and comprises
(a) a deaeration device that deaerates purified water of a supplied raw material through a hollow fiber membrane;
(b) a hydrogen dissolution device that dissolves pressurized hydrogen gas in deaerated water, which is supplied from the deaeration device, through the hollow fiber membrane;
(c) a filling device that fills a packaging container with a spout from an injection port of the packaging container with hydrogen-containing water supplied from the hydrogen dissolution device;
(d) a sealing device that seals the injection port of the packaging container with a spout completely filled with the hydrogen-containing water;
a pressure pump that is capable of applying pressure to water flow channels corresponding to the hydrogen-containing water, which is to be injected to the packaging container by the filling device (c), from the purified water that is to be supplied to the deaeration device (a);
a relief valve that is connected to a loop flow channel allowing the water flow channel, to which pressure has been applied by the pressure pump, to communicate with the water flow channel to which pressure is not yet applied, closes the loop flow channel when water pressure of the water flow channel to which pressure has been applied is lower than a certain reference pressure, and opens the loop flow channel when the water pressure exceeds the certain reference pressure; and
an orifice that is connected to the water flow channel provided ahead of the filling device (c) and limits the flow rate of hydrogen-containing water, to which the reference pressure is applied and which is to be supplied to the filling device (c), to a certain reference flow rate or less,
wherein the filling device (c) includes a cavity that is formed in a device body and is connected to a filling port, and includes a stem valve that is capable of reciprocating so that a tip portion of the stem valve faces the filling port,
the cavity communicates with the water flow channel extending from the hydrogen dissolution device (b),
the stem valve is a valve mechanism that allows the injection port of the packaging container, which is connected to the filling port, to communicate with the water flow channel extending from the hydrogen dissolution device (b) and blocks the communication of the injection port by the reciprocation thereof,
the cavity is connected to gas decompression means and gas pressurization means through a gas channel that is formed in the stem valve or formed along an outer surface of the stem valve, and
the gas channel is adapted to be opened and closed by the reciprocation of the stem valve.

11. The method of manufacturing hydrogen-containing drinking water according to claim 4,
wherein the reference pressure is in the range of 0.1 MPa to 0.5 MPa.

12. The method of manufacturing hydrogen-containing drinking water according to claim 5,
wherein the reference pressure is in the range of 0.1 MPa to 0.5 MPa.

13. The method of manufacturing hydrogen-containing drinking water according to claim 6,
wherein the reference pressure is in the range of 0.1 MPa to 0.5 MPa.
